(19) United States
(12) Patent Application Publication
(10) Pub. No.: US 2026/0188739 A1
(43) Pub. Date: Jul. 2, 2026

(54) ELECTROLYTE FOR FLUORIDE BATTERY, POLYMER ELECTROLYTE, AND FLUORIDE BATTERY

(71) Applicants: KYOTO UNIVERSITY, Kyoto-shi (JP); DAIKIN INDUSTRIES, LTD., Osaka (JP)

(72) Inventors: Takeshi ABE, Kyoto-shi (JP); Ryo SAKAMOTO, Kyoto-shi (JP); Kentaro HIRAGA, Osaka (JP); Takaya YAMADA, Osaka (JP)

(73) Assignees: KYOTO UNIVERSITY, Kyoto-shi (JP); DAIKIN INDUSTRIES, LTD., Osaka (JP)

(21) Appl. No.: 19/549,158

(22) Filed: Feb. 25, 2026

Related U.S. Application Data
(63) Continuation of application No. PCT/JP2024/031048, filed on Aug. 29, 2024.

(30) Foreign Application Priority Data
Aug. 31, 2023 (JP) 2023-141397

(51) Int. Cl. H01M 10/0565

(52) U.S. Cl. CPC H01M 10/0565; H01M 2300/0082

(57) ABSTRACT

An electrolyte solution for a fluoride battery, which is low in volatility and flame-retardant, as well as a polymer electrolyte containing the electrolyte solution for a fluoride battery and a fluoride battery. An electrolyte solution for a fluoride battery, containing: a fluoropolyether; and a fluoride salt.

### CROSS-REFERENCE TO RELATED APPLICATIONS

This is a Rule 53(b) Continuation of International Application No. PCT/JP2024/031048 filed Aug. 29, 2024, claiming priority based on Japanese Patent Application No. 2023-141397 filed Aug. 21, 2023, the respective disclosures of which are incorporated herein by reference in their entirety.

### TECHNICAL FIELD

The disclosure relates to electrolyte solutions for fluoride batteries, polymer electrolytes, and fluoride batteries.

### BACKGROUND ART

Current electric appliances demonstrate a tendency to have a reduced weight and a smaller size, which leads to development of electrochemical devices having a high energy density.

Fluoride-ion batteries, a type of electrochemical device, are characterized by their high voltage operation using fluoride ions (F⁻) as charge carriers, and various studies are being conducted on them (See Patent Literatures 1 and 2).

### CITATION LIST

### Patent Literature

Patent Literature 1: JP 2014-501434 T
Patent Literature 2: JP 2022-128927 A

### SUMMARY

The disclosure (1) relates to an electrolyte solution for a fluoride battery, containing: a fluoropolyether; and a fluoride salt.

### DESCRIPTION OF EMBODIMENTS

The disclosure is described in detail below.

### <Composition>

The disclosure relates to an electrolyte solution for a fluoride battery, containing: a fluoropolyether; and a fluoride salt.

The electrolyte solution of the disclosure, with the above formulation, can achieve low volatility and flame retardancy.

The fluoropolyether suitably contains at least one compound represented by any of the following formulas (1) to (4). These compounds allow achievement of low volatility and flame retardancy owing to the Rb¹ to Rb⁴ moieties. The compounds of the formulas (1) to (3) improve the solubility of a fluoride salt owing to the presence of Ra¹ to Ra³ moieties.

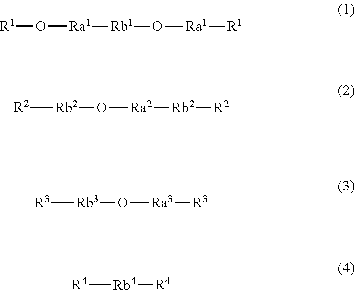

In the formulas, Ra¹ to Ra³ are each independently a group containing at least one of a fluorine-free alkylene unit or a fluorine-free oxyalkylene unit;
each oxyalkylene unit in Ra¹ to Ra³ is independently —CH₂CH₂O— or —CH₂CH(J)O—;
each J is independently an alkyl group or an aryl group;
Rb¹ to Rb⁴ are each independently a fluoropolyether group represented by the following formula (5);
R¹ to R³ are each independently a hydrogen atom, a hydroxy group, a fluorine atom, a C1-C3 alkyl group, an aryl group, or a C1-C3 fluoroalkyl group; and
each R⁴ is independently a fluorine atom, a hydrogen atom, a hydroxy group, an aldehyde group, a carboxylic acid group, a C1-C10 alkyl ester group, an amide group optionally containing a substituent, or an amino group optionally containing a substituent,

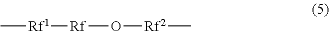

wherein Rf¹ and Rf² are each independently a C1-C16 alkylene group optionally substituted with a fluorine atom, and
Rf is a divalent fluoropolyether group.

The alkylene units in Ra¹ to Ra³ may be linear or branched, and are preferably linear. They each preferably have a carbon number of 1 to 3.

When the oxyalkylene units in Ra¹ to Ra³ are each —CH₂CH(J)O—, J as an alkyl group may be linear or branched, and is preferably linear. The alkyl group for J preferably has a carbon number of 1 to 3.

Examples of aryl groups for J include a phenyl group, a 4-nitrophenyl group, a 4-acetylaminophenyl group, and a 4-methanesulfonylphenyl group.

In Ra¹ to Ra³, the total number of fluorine-free alkylene units and fluorine-free oxyalkylene units is preferably 4 to 50.

Ra¹ to Ra³ preferably each independently include at least an oxyalkylene unit, more preferably each independently include a polyoxyalkylene unit represented by the following formula (Ra-I),

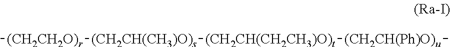

wherein r, s, t, and u are each independently an integer of 0 or 1 or greater, and r+s+t+u is 4 to 50.

In the formula (Ra-I), r is preferably 1 or greater, more preferably 2 or greater, while it is preferably 30 or smaller, more preferably 20 or smaller.

s, t, and u are each preferably 10 or smaller, more preferably 5 or smaller, still more preferably 0.

r+s+t+u is preferably 1 or greater, more preferably 2 or greater, while it is preferably 20 or smaller, more preferably 10 or smaller.

Ra¹ to Ra³ each have a number average molecular weight of preferably 40 or greater, more preferably 100 or greater, while preferably 4000 or smaller, more preferably 1000 or smaller.

The number average molecular weights of Ra¹ to Ra³ herein are measured by 1H-NMR.

In Rb¹ to Rb⁴, the alkylene groups for Rf¹ and Rf² in the formula (5) may be linear or branched, and are preferably linear.

The alkylene groups for Rf¹ and Rf² are each preferably a fluorine-substituted alkylene group substituted with a fluorine atom.

The alkylene groups for Rf¹ and Rf² each preferably have a carbon number of 1 to 3.

In Rb¹ to Rb⁴, Rf in the formula (5) may have a cyclic structure.

In Rb¹ to Rb⁴, Rf in the formula (5) is preferably a fluoropolyether group represented by the following formula (Rf-I),

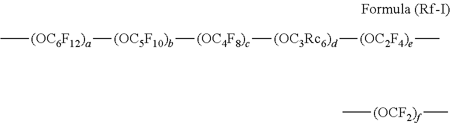

wherein each Rc is independently a hydrogen atom, a fluorine atom, or a chlorine atom;
a, b, c, d, e, and f are each independently an integer of 0 to 200;
a sum of a, b, c, d, e, and f is 1 or greater;
repeating units with a, b, c, d, e, and f are present in an arbitrary order; and
at least one of a, b, c, e, and f is 1 or greater when all Rcs are hydrogen atoms or chlorine atoms.

Rc is preferably a hydrogen atom or a fluorine atom, more preferably a fluorine atom. In other words, Rf in the formula (5) is preferably a perfluoropolyether group.

a, b, c, d, e, and f are preferably each independently an integer of 0 to 100.

The sum of a, b, c, d, e, and f is preferably 5 or greater, more preferably 10 or greater, and may be 15 or greater or 20 or greater. The sum of a, b, c, d, e, and f is preferably 100 or smaller, more preferably 60 or smaller, and may be 50 or smaller or 30 or smaller.

The repeating units with a, b, c, d, e, and f each may be linear or branched.

—(OC₆F₁₂)— may be, for example, any of —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, and —(OCF₂CF₂CF₂CF₂CF(CF₃))—.

—(OC₅F₁₀)— may be, for example, any of —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, and —(OCF₂CF₂CF₂CF(CF₃)).

—(OC₄F₈)— may be, for example, any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C2F₅)CF₂)—, and —(OCF₂CF(C2F₅)).

—(OC₃F₆)— (specifically, the case where all Rcs in the formula (Rf-I) are fluorine atoms) may be, for example, any of —(OCF₂CF₂CF₂)—, —(OCF(CF₃)CF₂)—, and —(OCF₂CF(CF₃))—.

—(OC₂F₄)— may be, for example, either —(OCF₂CF₂)— or —(OCF(CF₃))—.

Rf may be a group represented by any of the following formulas (Rf-I-I) to (Rf-I-V),

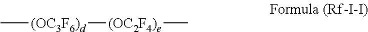

wherein d is an integer of 1 to 200 and e is 0 or 1,

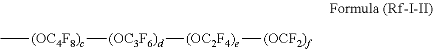

wherein c and d are each independently an integer of 0 to 30;
e and f are each independently an integer of 1 to 200;
a sum of c, d, e, and f is 2 or greater; and
repeating units with c, d, e, and f are present in an arbitrary order,

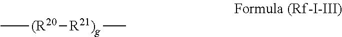

wherein R²⁰ is OCF₂ or OC₂F₄,
R²¹ is a group selected from OC₂F₄, OC₃F₆, OC₄F₈, OC₅F₁₀, and OC F₁₂ or a combination of two or three groups selected from the aforementioned groups, and
g is an integer of 2 to 100;

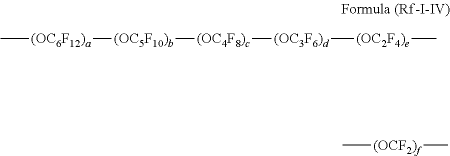

wherein e is an integer of 1 to 200,
a, b, c, d, and f are each independently an integer of 0 to 200, and
repeating units with a, b, c, d, e, and f are present in an arbitrary order; and

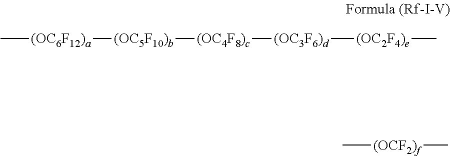

wherein f is an integer of 1 to 200,
a, b, c, d, and e are each independently an integer of 0 to 200, and
repeating units with a, b, c, d, e, and f are present in an arbitrary order.

In the formula (Rf-I-I), d may be preferably 5 to 200, more preferably 10 to 100, still more preferably 10 to 30.

The group represented by the formula (Rf-I-I) is preferably a group represented by —(OCF₂CF₂CF₂)_{d}— or —(OCF(CF₃)CF₂)_{d}—.

In the formula (Rf-I-II), e and f are each independently an integer of preferably 5 to 200, more preferably 10 to 200. The sum of c, d, e, and f is preferably 5 or greater, more preferably 10 or greater, and may be 15 or greater or 20 or greater.

The group represented by the formula (Rf-I-II) is preferably a group represented by —(OCF₂CF₂CF₂CF₂)_{c}—(OCF₂CF₂CF₂)_{d}—(OCF₂CF₂)ₑ—(OCF₂)_{f}— or a group represented by —(OC₂F₄)ₑ—(OCF₂)_{f}—, more preferably a group represented by —(OC₂F₄)ₑ—(OCF₂)_{f}—.

In the formula (Rf-I-III), R²⁰ is preferably OC₂F₄, R²¹ is preferably a group selected from OC₂F₄, OC₃F₆, and OC₄F₈ or a combination of two or three groups independently selected from the aforementioned groups, more preferably a group selected from OC₃F₆ and OC₄F₈. Non-limiting examples of the combination of two or three groups independently selected from OC₂F₄, OC₃F₆, and OC₄F₈ include —OC₂F₄OC3F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC2F₄OC3F₆—, —OC₂F₄OC2F₄OC₄F₈—, —OC₂F₄OC3F₆OC₂F₄—, —OC₂F₄OC3F₆OC₃F₆—, —OC₂F₄OC₄F₈OC₂F₄—, —OC₃F₆OC₂F₄OC2F₄—, —OC₃F₆OC₂F₄OC3F₆—, —OC₃F₆OC₃F₆OC₂F₄—, and —OC₄F₈OC₂F₄OC₂F₄—.

In the formula (Rf-I-III), g is an integer of preferably 3 or greater, more preferably 5 or greater. g is preferably an integer of 50 or smaller.

In the formula (Rf-I-III), OC₂F₄, OC₃F₆, OC₄F₈, OC₅F₁₀, and OC₆F₁₂ may be linear or branched, and are preferably linear. In this embodiment, the formula (Rf-I-III) preferably represents —(OC₂F₄—OC₃F₆)_{g}— or —(OC₂F₄—OC₄F₈)_{g}—.

In the formula (Rf-I-IV), e is an integer of preferably 1 to 100, more preferably 5 to 100. The sum of a, b, c, d, e, and f is preferably 5 or greater, more preferably 10 or greater, and is, for example, 10 to 100.

In the formula (Rf-I-V), f is an integer of preferably 1 to 100, more preferably 5 to 100. The sum of a, b, c, d, e, and f is preferably 5 or greater, more preferably 10 or greater, and is, for example, 10 to 100.

The ratio of e to f (hereafter, referred to as “e/f ratio”) in Rf may be 0.5 to 4, and is preferably 0.6 to 3, more preferably 0.7 to 2, still more preferably 0.8 to 1.4. Setting the e/f ratio to 4 or smaller further improves the lubricity and chemical stability. The smaller the e/f ratio, the higher the lubricity. Setting the e/f ratio to 0.5 or greater can further enhance the stability of the compound. The greater the e/f ratio, the better the stability of the fluoropolyether structure. In this case, the value of the e/f ratio is preferably 0.8 or greater.

Rf may be a group represented by the following formula (Rf-I-VI):

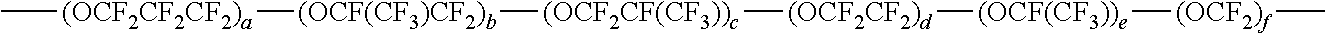

wherein a, b, c, d, e, and f are each independently an integer of 0 to 200,
the sum of a, b, c, d, e, and f is 1 or greater, and
repeating units with a, b, c, d, e, and f are present in an arbitrary order.

Rf may be a group represented by the following formula (Rf-I-VII):

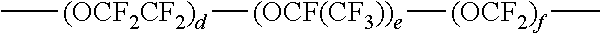

wherein d, e, and f are each independently an integer of 0 to 200,
the sum of d, e, and f is 1 or greater, and
repeating units with d, e, and f are present in an arbitrary order.

In the case where Rf is this group, the salt solubility is expected to be better because an increase in the number of ether bonds facilitates coordination of salt cations.

The ratio of d to f (hereafter, referred to as “d/f ratio”) in Rf may be 0.5 to 4, and is preferably 0.6 to 3, more preferably 0.7 to 2, still more preferably 0.8 to 1.4. Setting the d/f ratio to 4 or smaller further improves the lubricity and chemical stability. The smaller the d/f ratio, the higher the lubricity. Setting the d/f ratio to 0.5 or greater can further enhance the stability of the compound. The greater the d/f ratio, the better the stability of the fluoropolyether structure. In this case, the value of the d/f ratio is preferably 0.8 or greater.

Each Rf is independently preferably a group represented by the formula (Rf-I-I) or the formula (Rf-I-II), more preferably a group represented by the formula (Rf-I-II).

Rf may have a number average molecular weight of, but not limited to, for example, 500 to 30000, preferably 1500 to 30000, more preferably 2000 to 10000.

The number average molecular weight of Rf herein is measured by ¹⁹F-NMR.

The alkyl or fluoroalkyl group for R¹ to R³ may be linear or branched, and is preferably linear.

Examples of aryl groups for R¹ to R³ include a phenyl group, a 4-nitrophenyl group, a 4-acetylaminophenyl group, and a 4-methanesulfonylphenyl group.

R¹ to R³ are each independently preferably a C1-C3 alkyl group or a C1-C3 fluoroalkyl group, more preferably a methyl group, an ethyl group, a trifluoromethyl group, or a pentafluoroethyl group, still more preferably a methyl group, a trilfluoromethyl group, or a pentafluoroethyl group.

The alkyl ester group for R⁴ may be linear or branched.

Examples of the substituent contained in the amide or amino group for R⁴ include an alkyl group, an alkoxy group, and a hydroxy group.

Each R⁴ is independently preferably a fluorine atom, a hydrogen atom, a hydroxy group, an aldehyde group, a carboxylic acid group, a C1-C10 alkyl ester group, an amide group optionally containing a substituent, or an amino group optionally containing a substituent, more preferably a fluorine atom.

When R⁴ is a fluorine atom, R⁴—Rb⁴ and Rb⁴—R⁴, that is, R⁴—Rf¹ and Rf²—R⁴ may be each independently a group selected from the group consisting of —CF₃, —CF₂CF₃, and —CF₂CF₂CF₃.

In order to achieve, for example, good ion conductivity, the fluoropolyether is preferably represented by the formula (1).

In order to achieve, for example, good ion conductivity, the fluoropolyether is preferably liquid at a temperature within a range of 25° C. to 80° C.

Examples of the form “liquid at a temperature within a range of 25° C. to 80° C.” include a form “solid at 25° C. and liquid at 50° C.” and a form “solid at 50° C. and liquid at 80° C.”. The form “liquid at a low temperature and solid at a high temperature” is not included in the form “liquid at a temperature within a range of 25° C. to 80° C.” because such a form does not normally exist.

The amount of the fluoropolyether in the electrolyte solution for a fluoride ion battery of the disclosure is preferably 60% by mass or more, more preferably 70% by mass or more, still more preferably 80% by mass or more. The upper limit is not limited, and is normally 99% by mass or less, preferably 98% by mass or less.

The fluoride salt may be any fluoride salt that generates fluoride ions, and may be an organic fluoride salt or an inorganic fluoride salt. The fluoride salt may also be an ionic liquid. More specifically, a fluoride salt such as an ammonium fluoride or a metal fluoride can be used. Each of these may be used alone or two or more of these may be used in combination. An ammonium fluoride is preferred for good solubility.

More specific examples of the metal fluoride include alkali or alkaline earth fluorides (e.g., LiF, NaF, KF, CSF, MgF₂, BaF₂), transition metal fluorides (e.g., VF₄, FeF₃, MoF₆, PdF₂, AgF), main-group metal fluorides (e.g., AlF₃, PbF₄, BiF₃), and lanthanide or actinide fluorides (e.g., LaF₃, YbF₃, UF₅). The metal fluoride is preferably LiF, NaF, KF, or CsF.

Examples of the ammonium fluoride include ammonium hydrogen fluoride and alkylammonium fluorides. An alkylammonium fluoride is preferred for good solubility.

The alkylammonium fluoride preferably contains a cation represented by N⁺-Rx₄. Each Rx is independently an alkyl group or a fluoroalkyl group, and is preferably an alkyl group. The carbon number of Rx is, for example, 1 to 10 and may be 5 or less or 3 or less. The alkylammonium fluoride is preferably tetramethylammonium fluoride or tetrabutylammonium fluoride.

The alkyl and fluoroalkyl groups in the alkylammonium fluoride may each be linear or branched. At least one of them is preferably branched, and more preferably contains both branched and linear chains.

The carbon numbers of the alkyl and fluoroalkyl groups are each preferably 1 or more, while they are each preferably 10 or less, more preferably 8 or less, still more preferably 6 or less.

The carbon numbers of the linear alkyl and linear fluoroalkyl groups are each preferably 1 or more, while they are each preferably 10 or less, more preferably 5 or less, still more preferably 3 or less.

The carbon numbers of the branched alkyl and branched fluoroalkyl groups are each preferably 1 or more, more preferably 3 or more, still more preferably 4 or more, while they are each preferably 10 or less, more preferably 8 or less, still more preferably 6 or less.

The alkylammonium fluoride is preferably an alkylammonium fluoride containing a C5 branched alkyl group, more preferably an alkylammonium fluoride containing a neopentyl group, still more preferably trimethyl neopentylammonium fluoride or dimethyl dineopentylammonium fluoride, particularly preferably trimethyl neopentylammonium fluoride.

The amount of the fluoride salt in the electrolyte solution for a fluoride battery of the disclosure is preferably 0.1% by mass or more, more preferably 1% by mass or more, while it is preferably 10% by mass or less, more preferably 5% by mass or less.

The fluoropolyether in the electrolyte solution for a fluoride battery of the disclosure is normally used as a solvent.

The amount of the fluoropolyether is preferably 70% by volume or more, more preferably 80% by volume or more, still more preferably 90% by volume or more based on the solvent. The upper limit may be, but is not limited to, 100% by mass.

The electrolyte solution for a fluoride battery of the disclosure may contain a solvent other than the fluoropolyether. Examples of the solvent other than the fluoropolyether include solvents conventionally known as non-aqueous solvents for fluoride ion batteries, such as carbonate-based solvents, ester-based solvents, ether-based solvents, and fluorobenzene-based solvents. Examples of carbonate-based solvents include cyclic carbonates such as ethylene carbonate, propylene carbonate, butylene carbonate, and vinylene carbonate, and acyclic carbonates such as dimethyl carbonate, diethyl carbonate, and methyl ethyl carbonate. Examples of ester-based solvents include cyclic esters such as γ-butyrolactone and γ-valerolactone and acyclic esters such as methyl acetate and ethyl acetate. Examples of ether-based solvents include cyclic ethers such as tetrahydrofuran and 2-methyltetrahydrofuran and acyclic ethers such as dimethoxyethane and glyme-based compounds. Examples of glyme-based compounds include diethylene glycol diethyl ether, triethylene glycol dimethyl ether, and tetraethylene glycol dimethyl ether. Examples of fluorobenzene-based solvents include 1,3-difluorobenzene, 1,2,4-trifluorobenzene, and 1,2,3,4-tetrafluorobenzene. Each of these may be used alone or two or more of these may be used in combination. Preferred in the disclosure is an ether-based solvent, more preferred is an acyclic ether, and still more preferred is a glyme-based compound.

The electrolyte solution for a fluoride battery of the disclosure may contain at least one anion acceptor selected from the group consisting of tris(hexafluoroisopropyl)borate, tris(pentafluorophenyl)borane, difluorophenylboroxine, trifluorophenylboroxine, bis(trifluoromethyl)phenylboroxine, trifluoromethylphenylboroxine, triphenylboroxine, trimethoxyboroxine, fluorobis(2,4,6-trimethylphenyl)borane, 4-(4,4,5,5-tetramethyl-1,3,2-dioxaborolan-2-yl)pyridine, N,N-diethyl-4-(4,4,5,5-tetramethyl-1,3,2-dioxaborolan-2-yl)aniline, and fluoro (trifluoromethyl)phenylboroxine. These anion acceptors are believed to reversibly bind to fluoride ions in solution, increasing the amount of fluoride salts dissolved in the solution. The reversible complexation between these anion acceptors and fluoride ions is expected to reduce the amount of free fluoride ions in the solution, leading to better stability of the cycle characteristics.

The amount of the anion acceptor in the electrolyte solution for a fluoride battery of the disclosure is preferably 0.001 to 20% by mass, more preferably 0.01 to 15% by mass, still more preferably 0.1 to 10% by mass, particularly preferably 0.1 to 7% by mass, based on the electrolyte solution.

The electrolyte solution may further contain a polyethylene oxide that has a weight average molecular weight of 2000 to 4000 and has —OH, —OCOOH, or —COOH at an end.

The presence of such a compound can improve the stability at the interfaces with the respective electrodes, improving the characteristics of the fluoride battery.

Examples of the polyethylene oxide include polyethylene oxide monool, polyethylene oxide carboxylic acid, polyethylene oxide diol, polyethylene oxide dicarboxylic acid, polyethylene oxide triol, and polyethylene oxide tricarboxylate. One of these may be used alone or two or more thereof may be used in any combination.

In order to give better fluoride battery characteristics, preferred are a mixture of polyethylene oxide monool and polyethylene oxide diol and a mixture of polyethylene carboxylic acid and polyethylene dicarboxylic acid.

The polyethylene oxide having too small a weight average molecular weight may be easily oxidatively decomposed. The weight average molecular weight is more preferably 3000 to 4000.

The weight average molecular weight can be determined by gel permeation chromatography (GPC) in polystyrene equivalent.

The polyethylene oxide is preferably contained in an amount of 1×10⁻⁶ to 1×10⁻² mol/kg in the electrolyte solution. Too large an amount of the polyethylene oxide may impair the characteristics of the fluoride battery.

The amount of the polyethylene oxide is more preferably 5×10⁻⁶ mol/kg or more.

The electrolyte solution for a fluoride battery of the disclosure is preferably liquid at 25° C.

The electrolyte solution for a fluoride battery of the disclosure preferably has an ion conductivity of 1.0×10⁻⁹ S/cm or higher, more preferably 1.0×10⁻⁸ S/cm or higher, still more preferably 1.0×10⁻⁷ S/cm or higher. The upper limit is preferably, but not limited to, 1.0×10⁻⁴ S/cm or lower.

The ion conductivity can be measured at 25° C. using SevenCompact S230 available from Mettler Toledo.

The electrolyte solution for a fluoride battery of the disclosure preferably has a fluoride ion transference number of preferably 0.1 or more, more preferably 0.2 or more, still more preferably 0.3 or more. The upper limit thereof is preferably, but not limited to, 0.8 or less.

The fluoride ion transference number can be obtained by pulsed field gradient NMR using fluoride ions as the target nuclide (Science 362, 1144-1148, (2018)).

### <Polymer Electrolyte>

The disclosure also relates to a polymer electrolyte containing the electrolyte solution for a fluoride battery of the disclosure.

Examples of the polymer electrolyte of the disclosure include a gel electrolyte prepared by plasticizing a polymer material with the electrolyte solution for a fluoride battery of the disclosure.

Examples of the polymer material include conventionally known polyethylene oxide and polypropylene oxide, and modified products thereof (see JP H08-222270 A, JP 2002-100405 A); polyacrylate-based polymers, polyacrylonitrile, and fluororesins such as polyvinylidene fluoride and vinylidene fluoride-hexafluoropropylene copolymers (see JP H04-506726 T, JP H08-507407 T, JP H10-294131 A); and composites of any of these fluororesins and any hydrocarbon resin (see JP H11-35765 A, JP H11-86630 A). Particularly preferred is polyvinylidene fluoride.

### <Fluoride Battery>

The disclosure also relates to a fluoride battery containing the electrolyte solution for a fluoride battery of the disclosure or the polymer electrolyte of the disclosure.

The fluoride battery of the disclosure preferably includes components such as a positive electrode and a negative electrode. The fluoride battery of the disclosure is particularly preferably a fluoride ion secondary battery including these components.

Examples of the positive electrode active material used in the positive electrode include metals forming metal fluorides. Specific examples include Au, Pt, S, Ag, Fe, Co, Ni, Cu, Cr, Mo, W, V, Sb, Bi, Sn, In, Ce, and Pb. Each of these may be used alone or two or more of these may be used in combination. The positive electrode active material may be an alloy of two or more metals or a fluoride of any of these metals. The positive electrode active material may be, for example, a foil, a compact, or one formed by vapor deposition.

In order to achieve a high battery capacity, the amount of the positive electrode active material is preferably 50 to 99.5% by mass, more preferably 80 to 99% by mass, of the positive electrode mixture. The amount of the positive electrode active material in the positive electrode active material layer is preferably 80% by mass or more, more preferably 82% by mass or more, particularly preferably 84% by mass or more. The upper limit thereof is preferably 99% by mass or less, more preferably 98% by mass or less. Too small an amount of the positive electrode active material in the positive electrode active material layer may lead to an insufficient electric capacity. In contrast, too large an amount thereof may lead to insufficient strength of the positive electrode.

The negative electrode active material used in the negative electrode may be, for example, a material that occludes and releases carrier ions. It may be a material that adsorbs and desorbs carrier ions like a capacitor or a material that inserts and desorbs carrier ions like an ion secondary battery. Specific examples include: noble metals such as Pt, Au, and Ag; lithium metal; carbonaceous materials such as artificial graphite, graphite carbon fiber, resin sintered carbon, pyrolytic vapor grown carbon, coke, mesocarbon microbeads (MCMB), furfuryl alcohol resin sintered carbon, polyacene, pitch-based carbon fiber, vapor-grown carbon fiber, natural graphite, and non-graphitizable carbon; silicon-containing compounds such as silicon and silicon alloys; and Li₄Ti₅O₁₂.

In order to increase the capacity of the resulting electrode mixture, the amount of the negative electrode active material in the electrode mixture is preferably 40% by mass or more, more preferably 50% by mass or more, particularly preferably 60% by mass or more. The upper limit thereof is preferably 99% by mass or less, more preferably 98% by mass or less.

The positive electrode current collector is a conductor and is not limited as long as it has a redox potential nobler than that of the positive electrode active material. Examples thereof include C, Au, Pt, Ag, Co, Mo, Cu, W, V, Sb, Bi, Sn, Ni, Pb, Fe, Cr, Zn, In, Ti, Ga, Mn, Al, and Zr.

The negative electrode current collector used may be the same as the positive electrode current collector.

The electrode mixture contained in the positive electrode or the negative electrode may contain a conductive aid.

Non-limiting examples of the conductive aid include carbon materials such as carbon black, including acetylene black, Ketjen black, channel black, furnace black, lamp black, and thermal black, and amorphous carbon, including fullerene and VGCF. One of these may be used alone or two or more thereof may be used in any combination at any ratio.

The conductive aid is used in an amount of usually 0.01% by mass or more, preferably 0.1% by mass or more, more preferably 1% by mass or more, while usually 50% by mass or less, preferably 30% by mass or less, more preferably 15% by mass or less, in the electrode mixture.

The electrode mixture may contain a binder.

Non-limiting examples of the binder include polymer compositions such as styrene butadiene rubber (SBR), acrylonitrile butadiene rubber (NBR), ethylene-propylene-diene terpolymer (EPDM), polyvinylidene fluoride, and tetrafluoroethylene.

The binder is used in an amount of usually 1.0% by mass or more, preferably 1.3% by mass or more, more preferably 1.6% by mass or more, while usually 20% by mass or less, preferably 15% by mass or less, more preferably 10% by mass or less, still more preferably 8% by mass or less, relative to the electrode active material.

The positive electrode and the negative electrode may be produced by a usual method. In an exemplary method, a slurry containing an electrode composition is prepared and applied to a current collector, followed by drying.

The positive and negative electrodes each may have any thickness. In order to achieve a high capacity and high output, the lower limit of the thickness of the mixture layer on one side of the current collector excluding the thickness of the metal foil of the current collector is preferably 10 μm or greater, more preferably 20 μm or greater, while preferably 500 μm or smaller, more preferably 450 μm or smaller.

The secondary battery containing the electrolyte solution for a fluoride battery of the disclosure preferably further includes a separator. The separator may be formed from any known material and may have any known shape as long as the resulting separator is stable to the electrolyte solution and is excellent in a liquid-retaining ability. The separator is preferably in the form of a porous sheet or a nonwoven fabric formed from a material stable to the electrolyte solution, such as resin, glass fiber, or inorganic matter, and having an excellent liquid-retaining ability.

Examples of the material of a resin or glass-fiber separator include polyolefins such as polyethylene and polypropylene, aromatic polyamides, polytetrafluoroethylene, polyether sulfone, and glass filters. One of these materials may be used alone or two or more thereof may be used in any combination at any ratio. In order to achieve good permeability of the electrolyte solution and a good shut-down effect, the separator is preferably a porous sheet or a nonwoven fabric formed from a polyolefin such as polyethylene or polypropylene.

The external case may be made of any material that is stable to the electrolyte to be used. Specific examples thereof include metals such as nickel-plated steel plates, stainless steel, aluminum and aluminum alloys, and magnesium alloys, and a layered film (laminate film) of resin and aluminum foil. In order to reduce weight, a metal such as aluminum or an aluminum alloy or a laminate film is favorably used.

The secondary battery containing the electrolyte solution may have any shape, such as a cylindrical shape, a square shape, a laminate shape, a coin shape, or a large-size shape. The shapes and the structures of the positive electrode, the negative electrode, and the separator may be changed in accordance with the shape of the battery.

The embodiments have been described above, and it will be understood that various changes in form or detail can be made without departing from the gist and scope of the claims.

The disclosure (1) relates to an electrolyte solution for a fluoride battery, containing: a fluoropolyether; and a fluoride salt.

The disclosure (2) relates to the electrolyte solution for a fluoride battery according to the disclosure (1), wherein the fluoropolyether includes at least one compound represented by any of the following formulas (1) to (4):

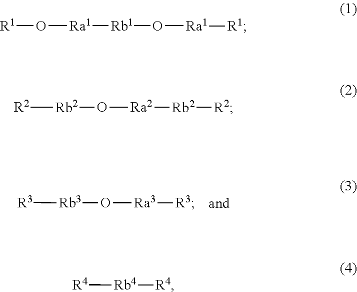

wherein Ra¹ to Ra³ are each independently a group containing at least one of a fluorine-free alkylene unit or a fluorine-free oxyalkylene unit;
each oxyalkylene unit in Ra¹ to Ra³ is independently —CH₂CH₂O— or —CH₂CH(J)O—;
each J is independently an alkyl group or an aryl group;
Rb¹ to Rb⁴ are each independently a fluoropolyether group represented by the following formula (5);
R¹ to R³ are each independently a hydrogen atom, a hydroxy group, a fluorine atom, a C1-C3 alkyl group, an aryl group, or a C1-C3 fluoroalkyl group; and
each R⁴ is independently a fluorine atom, a hydrogen atom, a hydroxy group, an aldehyde group, a carboxylic acid group, a C1-C10 alkyl ester group, an amide group optionally containing a substituent, or an amino group optionally containing a substituent,

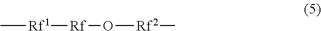

wherein Rf¹ and Rf² are each independently a C1-C16 alkylene group optionally substituted with a fluorine atom, and
Rf is a divalent fluoropolyether group.

The disclosure (3) relates to the electrolyte solution for a fluoride battery according to the disclosure (2), wherein the Ra¹ to Ra³ are each independently a polyoxyalkylene group represented by the following formula (Ra-I),

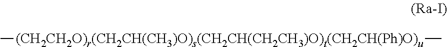

wherein r, s, t, and u are each independently an integer of 0 or 1 or greater, and r+s+++u is 4 to 50.

The disclosure (4) relates to the electrolyte solution for a fluoride battery according to the disclosure (2) or (3), wherein the Ra¹ to Ra³ each have a number average molecular weight of 40 to 4000.

The disclosure (5) relates to the electrolyte solution for a fluoride battery according to any one of the disclosures (2) to (4), wherein each Rf is independently a fluoropolyether group represented by the following formula (Rf-I),

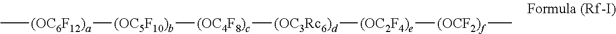

wherein each Rc is independently a hydrogen atom, a fluorine atom, or a chlorine atom;
a, b, c, d, e, and f are each independently an integer of 0 to 200;
a sum of a, b, c, d, e, and f is 1 or greater;
repeating units with a, b, c, d, e, and f are present in an arbitrary order; and
at least one of a, b, c, e, and f is 1 or greater when all Rcs are hydrogen atoms or chlorine atoms.

The disclosure (6) relates to the electrolyte solution for a fluoride battery according to any one of the disclosures (2) to (5), wherein each Rf is independently a group represented by the following formula (Rf-I-I) or the following formula (Rf-I-II),

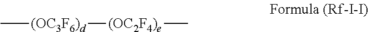

wherein d is an integer of 1 to 200 and e is 0 or 1, and Formula (Rf-I-II):

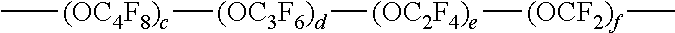

wherein c and d are each independently an integer of 0 to 30;
e and f are each independently an integer of 1 to 200;
a sum of c, d, e, and f is 2 or greater; and
repeating units with c, d, e, and f are present in an arbitrary order.

The disclosure (7) relates to the electrolyte solution for a fluoride battery according to any one of the disclosures (2) to (6), wherein the R¹ to R³ are each independently a methyl group, an ethyl group, a trifluoromethyl group, or a pentafluoroethyl group.

The disclosure (8) relates to the electrolyte solution for a fluoride battery according to any one of the disclosures (1) to (7), wherein the fluoride salt includes an ammonium fluoride or a metal fluoride.

The disclosure (9) relates to the electrolyte solution for a fluoride battery according to the disclosure (8), wherein the ammonium fluoride includes alkylammonium fluoride containing a neopentyl group.

The disclosure (10) relates to the electrolyte solution for a fluoride battery according to any one of the disclosures (1) to (9), wherein the fluoride salt is contained in an amount of 0.1 to 10% by mass.

The disclosure (11) relates to the electrolyte solution for a fluoride battery according to any one of the disclosures (1) to (10), wherein the electrolyte solution for a fluoride battery is liquid at 25° C.

The disclosure (12) relates to the electrolyte solution for a fluoride battery according to any one of the disclosures (1) to (11), wherein the electrolyte solution for a fluoride battery has an ion conductivity of 1.0×10⁻⁹ to 1.0×10⁻⁴ S/cm.

The disclosure (13) relates to a polymer electrolyte containing the electrolyte solution for a fluoride battery according to any one of the disclosures (1) to (12).

The disclosure (14) relates to a fluoride battery containing the electrolyte solution for a fluoride battery according to any one of the disclosures (1) to (12) or the polymer electrolyte according to the disclosure (13).

### EXAMPLES

The disclosure is described with reference to examples, but the disclosure is not intended to be limited by these examples.

The following compounds were used. Compounds 1-1 to Compounds 1-4 were liquid at 25° C.

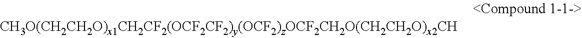

(x1: 4, y: 12.3 on average, z: 10.2 on average, x2: 4, the number average molecular weight of (CH₂CH₂O)ₓ₁: 176, the number average molecular weight of (CH₂CH₂O)ₓ₂: 176)

### <Compound 1-2>

Compound having the same structure as Compound 1-1 (x1: 8.4 on average, y: 12.3 on average, z: 10.2 on average, x2: 8.4 on average, the number average molecular weight of (CH₂CH₂O)ₓ₁: 400, the number average molecular weight of (CH₂CH₂O)ₓ₂: 400)

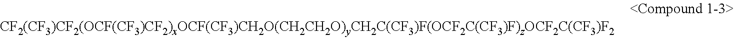

(x: 7 on average, y: 4.1 on average, z: 7 on average, the number average molecular weight of (CH₂CH₂O)_{y}: 200)

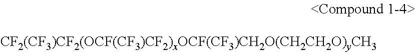

(x: 7 on average, y: 4, the number average molecular weight of (CH₂CH₂O)_{y}: 176)

### <Compound 2-1>

Ethyl methyl carbonate (EMC, available from Kishida Chemical Co., Ltd., boiling point: 108° C., flash point: 22° C.)

### <Compound 2-2>

Tetrafluoroethyl trifluoroethyl ether (available from Tokyo Chemical Industry Co., Ltd., boiling point: 56° C., no flash point)

### <Compound 2-3>

Triethylene glycol dimethyl ether (available from Tokyo Chemical Industry Co., Ltd., boiling point: 216° C., flash point: 108° C.)

### <LiF>

Lithium fluoride (available from FUJIFILM Wako Pure Chemical Corporation)

### <NaF>

Sodium fluoride (available from FUJIFILM Wako Pure Chemical Corporation)

### <KF>

Potassium fluoride (available from Tokyo Chemical Industry Co., Ltd.)

### <CsF>

Cesium fluoride (available from Tokyo Chemical Industry Co., Ltd.)

### <TMAF>

Tetramethylammonium fluoride (available from Sigma-Aldrich)

### <TBAF>

Tetrabutylammonium fluoride (available from Sigma-Aldrich)

### <NpAF>

Trimethylneopentylammonium fluoride (Synthesis Example 6 below)

### (Synthesis Example 1) Synthesis of Compound 1-1

A reaction vessel purged with nitrogen was charged with 600 mg of sodium hydroxide (available from Fujifilm Wako Pure Chemical Corporation, 15.3 mmol), 30 g of 1,3-bis(trifluoromethyl)benzene (available from Tokyo Chemical Industry Co., Ltd.), and 10 g of dialcohol-terminated fluoropolyether (available from Solvay, Fomblin D2, 5.1 mmol), followed by stirring with heating at 70° C. for three hours. The temperature inside the vessel was set to 65° C., and 5.5 g of triethylene glycol-2-bromoethyl methyl ether (available from Tokyo Chemical Industry Co., Ltd., 20.4 mmol) was dropped from a dropping funnel over 10 minutes, followed by stirring with heating for six hours. After returning to room temperature, 5 ml of 1 N hydrochloric acid was added to the reaction solution, followed by stirring for three hours. This solution was washed four times with pure water, and 2 g of magnesium sulfate was added to the separated organic layer, so that the organic layer was dried. Magnesium sulfate was removed from the treated solution by filtration. Volatile components were distilled off from the treated solution, followed by drying for three hours at 100° C., whereby Compound 1-1 was obtained.

### (Synthesis Example 2) Synthesis of Tosylate of Polyethylene Glycol Monomethyl Ether

A reaction vessel purged with nitrogen was charged with 8.0 g of polyethylene glycol monomethyl ether 400 (available from Tokyo Chemical Industry Co., Ltd., average molecular weight: 380 to 420, 20.0 mmol), 25 mL of tetrahydrofuran (available from Tokyo Chemical Industry Co., Ltd.), and 4.7 g of p-toluenesulfonyl chloride (available from Tokyo Chemical Industry Co., Ltd., 25 mmol), followed by stirring until uniform. The reaction vessel in an ice water bath was charged with a solution of 3.4 g of potassium hydroxide (available from Fujifilm Wako Pure Chemical Corporation, 60 mmol) in 10 mL of pure water, followed by stirring for 10 minutes. The reaction vessel was taken out of the ice water bath, and the contents were stirred for 12 hours at room temperature. The reaction solution was poured into a solution mixture of 30 mL of icy water and 60 mL of methylene chloride. The aqueous layer was extracted three times with methylene chloride. To the separated organic layer was added 8 g of magnesium sulfate, so that the organic layer was dried. Magnesium sulfate was removed from the treated solution by filtration. Volatile components were distilled off from the treated solution, whereby a tosylate of polyethylene glycol monomethyl ether was obtained.

### (Synthesis Example 3) Synthesis of Compound 1-2

Compound 1-2 was obtained by reacting the tosylate of polyethylene glycol monomethyl ether synthesized in Synthesis Example 2 in place of triethylene glycol-2-bromoethyl methyl ether under the reaction conditions of Synthesis Example 1.

### (Synthesis Example 4) Synthesis of Compound 1-3

A reaction vessel purged with nitrogen was charged with 600 mg of sodium hydroxide (available from Fujifilm Wako Pure Chemical Corporation, 15.3 mmol), 30 g of 1,3-bis(trifluoromethyl)benzene (available from Tokyo Chemical Industry Co., Ltd.), and 7.7 g of monoalcohol-terminated fluoropolyether (available from Uni-chem Co., Ltd., modified product of perfluoropolyether, molecular weight: 1500, 5.1 mmol), followed by stirring with heating at 70° C. for three hours. The temperature inside the vessel was set to 65° C., and a solution of 1.3 g (2.5 mmol) of ditosylate-terminated polyethylene glycol obtained in Synthesis Example 9 in 5 g of 1,3-bis(trifluoromethyl)benzene was dropped from a dropping funnel over 10 minutes, followed by stirring with heating for six hours. After returning to room temperature, 5 ml of 1 N hydrochloric acid was added to the reaction solution, followed by stirring for three hours. This solution was washed four times with pure water, and 2 g of magnesium sulfate was added to the separated organic layer, so that the organic layer was dried. Magnesium sulfate was removed from the treated solution by filtration. Volatile components were distilled off from the treated solution, followed by drying for three hours at 100° C., whereby Compound 1-3 was obtained.

### (Synthesis Example 5) Synthesis of Compound 1-4

A reaction vessel purged with nitrogen was charged with 600 mg of sodium hydroxide (available from Fujifilm Wako Pure Chemical Corporation, 15.3 mmol), 30 g of 1,3-bis(trifluoromethyl)benzene (available from Tokyo Chemical Industry Co., Ltd.), and 5.1 g of monoalcohol-terminated fluoropolyether (available from Uni-chem Co., Ltd., modified product of perfluoropolyether, molecular weight: 1500, 5.1 mmol), followed by stirring with heating at 70° C. for three hours. The temperature inside the vessel was set to 65° C., and 2.8 g of triethylene glycol-2-bromoethyl methyl ether (available from Tokyo Chemical Industry Co., Ltd., 10.0 mmol) was dropped from a dropping funnel over 10 minutes, followed by stirring with heating for six hours. After returning to room temperature, 5 ml of 1 N hydrochloric acid was added to the reaction solution, followed by stirring for three hours. This solution was washed four times with pure water, and 2 g of magnesium sulfate was added to the separated organic layer, so that the organic layer was dried. Magnesium sulfate was removed from the treated solution by filtration. Volatile components were distilled off from the treated solution, followed by drying for three hours at 100° C., whereby Compound 1-4 was obtained.

### (Synthesis Example 6) Synthesis of NpAF

Sodium carbonate (28.7 g) was added to a round-bottom flask containing a solution prepared by magnetically stirring methyl iodide (20 mL) and neopentylamine (11.8 mL) in ethanol (200 mL), whereby trimethylneopentylammonium iodide was prepared. After magnetic stirring at room temperature for 20 hours or longer, the mixture was suspended in ethanol (500 mL), filtered, and the solvent was removed on a hot stirrer. Then, the resulting solid was recrystallized from isopropanol (170 mL). The resulting crystals were dried in vacuum, whereby trimethylneopentylammonium iodide was obtained. The resulting trimethylneopentylammonium iodide (2 g), a fluoride ion exchange resin (3.5 g), and methanol (30 mL) were placed in a PTFE beaker, and left for 30 minutes. After filtering the solution, the filtrate was kept at 60° C. on a hot stirrer to remove the solvent. After removal of the solvent, a highly viscous solution was obtained. Isopropanol (6 mL) was added to the resulting solution, and dried in vacuum at 60° C., whereby brown crystals were obtained. The resulting crystals were transferred to a glove box, and isopropanol (2 mL) was added in the glove box. Then, the crystals were transferred to a sealable drying container and vacuum-dried at 60° C. for one whole day and night. The above drying operation was repeated twice. The resulting crystals were transferred to a sealable drying container and dried at 80° C. for one whole day and night, whereby white NpAF crystals were obtained.

### <Experiment 1> Examples 1 to 4, Comparative Examples 1 to 3

### (Preparation of Electrolyte Composition Containing Fluoride Salt)

Lithium fluoride (LiF, available from FUJIFILM Wako Pure Chemical Corporation) was added to the compound shown in Table 1 and stirred at 45° C. for 24 hours, whereby a composition containing 5% by mass of fluoride salt was obtained. The resulting composition obtained was pressure-filtered using a membrane filter (DISMIC 25HP045AN), whereby a sample for evaluation was prepared.

### (Volatility Test)

About 5 g of the sample was weighed into an aluminum cup and heated in a thermostatic chamber at 100° C. for five hours. The mass of the sample on the aluminum cup was then weighed, and the mass reduction rate of the sample was calculated using the following formula.

$$( Mass reduction rate of sample ) = 1 - ( Mass after heating ) / ( Mass before heating )$$

The mass reduction rate of 10% or lower was rated o (less volatile), and the mass reduction rate of higher than 10% was rated x (highly volatile).

### (Non-Flammability Test)

The non-flammability (non-ignition property) of the composition was examined by the following method.

### (Preparation of Sample)

A strip of cellulose paper (15 mm wide, 320 mm long, 0.04 mm thick) was thoroughly immersed in each of the compositions prepared in the above examples and comparative examples, and then taken out to prepare a sample.

### (Test Method)

The sample was secured to a metal base. A lighter flame was held near one end of the sample for one second, and ignition was checked.

The evaluation criteria were as follows: the case where the sample did not ignite (non-flammable) or where the sample ignited but the fire went out immediately (self-extinguishing) was rated o (Good), and the case where the sample ignited and continued to burn was rated x (Poor).

### (Ion Conductivity Measurement)

The ion conductivity was measured at 25° C. using SevenCompact S230 available from Mettler Toledo. The measuring device was calibrated in advance using a standard solution of 12.88 mS/cm before use.

TABLE 1

| | Example | | | | Comparative Example | | |
|---|---|---|---|---|---|---|---|
| | 1 | 2 | 3 | 4 | 1 | 2 | 3 |
| Compound | 1-1 | 1-2 | 1-3 | 1-4 | 2-1 | 2-2 | 2-3 |
| Volatility | ◯ | ◯ | ◯ | ◯ | X | X | ◯ |
| Non-flammability | ◯ | ◯ | ◯ | ◯ | X | ◯ | X |
| Ion conductivity S/cm | 4.2 × 10\hat{ }−8 | 7.9 × 10\hat{ }−8 | 2.5 × 10\hat{ }−8 | 6.8 × 10\hat{ }−8 | — | n.d | — |

### <Experiment 2> Examples 5 to 11

### (Preparation of Electrolyte Composition Containing Fluoride Salt)

Compound 1-1 and a fluoride salt shown in Table 2 were blended such that the salt concentration was 5% by mass and stirred at 45° C. for 24 hours, whereby a composition was obtained. The composition obtained was pressure-filtered using a membrane filter (DISMIC 25HP045AN), whereby a sample for evaluation was prepared.

The ion conductivity, volatility, and non-flammability were evaluated by the same methods as in Experiment 1.

TABLE 2

| | Example | | | | | | |
|---|---|---|---|---|---|---|---|
| | 5 | 6 | 7 | 8 | 9 | 10 | 11 |
| Fluoride salt | LIF | NaF | KF | CsF | TMAF | TBAF | NpAF |
| Ion conductivity S/cm | 4.2 × 10\hat{ }−8 | 3.3 × 10\hat{ }−8 | 9.3 × 10\hat{ }−8 | 8.0 × 10\hat{ }−8 | 3.3 × 10\hat{ }−8 | 7.2 × 10\hat{ }−8 | 2.3 × 10\hat{ }−8 |
| Volatility | ◯ | ◯ | ◯ | ◯ | ◯ | ◯ | ◯ |
| Non-flammability | ◯ | ◯ | ◯ | ◯ | ◯ | ◯ | ◯ |

1. An electrolyte solution for a fluoride battery, comprising:
a fluoropolyether including at least one compound represented by any of the following formulas (1) to (3): 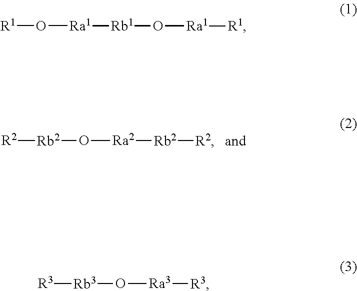
wherein Ra¹ to Ra³ are each independently a group containing at least one of a fluorine-free alkylene unit or a fluorine-free oxyalkylene unit;
each oxyalkylene unit in Ra¹ to Ra³ is independently —CH₂CH₂O— or —CH₂CH(J)O—;
each J is independently an alkyl group or an aryl group;
Rb¹ to Rb³ are each independently a fluoropolyether group represented by the following formula (5); and
R¹ to R³ are each independently a hydrogen atom, a hydroxy group, a fluorine atom, a C1-C3 alkyl group, an aryl group, or a C1-C3 fluoroalkyl group: 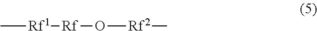
wherein Rf¹ and Rf² are each independently a C1-C16 alkylene group optionally substituted with a fluorine atom, and
Rf is a divalent fluoropolyether group; and
a fluoride salt.

2. The electrolyte solution for a fluoride battery according to claim 1,
wherein the Ra¹ to Ra³ are each independently a polyoxyalkylene group represented by the following formula (Ra-I), 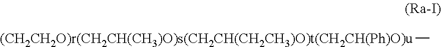
wherein r, s, t, and u are each independently an integer of 0 or 1 or greater, and r+s+t+u is 4 to 50.

3. The electrolyte solution for a fluoride battery according to claim 1,
wherein the Ra¹ to Ra³ each have a number average molecular weight of 40 to 4000.

4. The electrolyte solution for a fluoride battery according to claim 1,
wherein each Rf is independently a fluoropolyether group represented by the following formula (Rf-I),
formula (Rf-I): 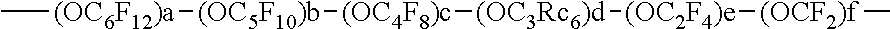
wherein each Rc is independently a hydrogen atom, a fluorine atom, or a chlorine atom;
a, b, c, d, e, and f are each independently an integer of 0 to 200;
a sum of a, b, c, d, e, and f is 1 or greater;
repeating units with a, b, c, d, e, and f are present in an arbitrary order; and
at least one of a, b, c, e, and f is 1 or greater when all Rcs are hydrogen atoms or chlorine atoms.

5. The electrolyte solution for a fluoride battery according to claim 1,
wherein each Rf is independently a group represented by the following formula (Rf-I-I) or the following formula (Rf-I-II),
formula (Rf-I-I): 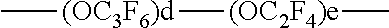
wherein d is an integer of 1 to 200 and e is 0 or 1, or formula (Rf-I-II): 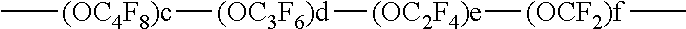
wherein c and d are each independently an integer of 0 to 30;
e and f are each independently an integer of 1 to 200;
a sum of c, d, e, and f is 2 or greater; and
repeating units with c, d, e, and f are present in an arbitrary order.

6. The electrolyte solution for a fluoride battery according to claim 1,
wherein the R¹ to R³ are each independently a methyl group, an ethyl group, a trifluoromethyl group, or a pentafluoroethyl.

7. The electrolyte solution for a fluoride battery according to claim 1,
wherein the fluoride salt includes an ammonium fluoride or a metal fluoride.

8. The electrolyte solution for a fluoride battery according to claim 7,
wherein the ammonium fluoride includes alkylammonium fluoride containing a neopentyl group.

9. The electrolyte solution for a fluoride battery according to claim 1,
wherein the fluoride salt is contained in an amount of 0.1 to 10% by mass.

10. The electrolyte solution for a fluoride battery according to claim 1,
wherein the electrolyte solution for a fluoride battery is liquid at 25° C.

11. The electrolyte solution for a fluoride battery according to claim 1,
wherein the electrolyte solution for a fluoride battery has an ion conductivity of 1.0×10⁻⁹ to 1.0×10⁻⁴ S/cm.

12. A polymer electrolyte comprising the electrolyte solution for a fluoride battery according to claim 1.

13. A fluoride battery comprising the electrolyte solution for a fluoride battery according to claim 1.

14. A fluoride battery comprising the electrolyte solution for a fluoride battery according to the polymer electrolyte according to claim 12.
